(19) United States
(12) Patent Application Publication
(10) Pub. No.: US 2023/0267389 A1
(43) Pub. Date: Aug. 24, 2023

(54) METHODS, SYSTEMS, AND DEVICES TO PREDICT WALK-OUT OF CUSTOMERS ASSOCIATED WITH A PREMISES

(71) Applicant: AT&T Intellectual Property I, L.P., Atlanta, GA (US)

(72) Inventors: Sumeet Aneja, Alpharetta, GA (US); John Francis, Atlanta, GA (US); Eli Schultz, Roswell, GA (US); Krishna Giduturi, Frisco, TX (US); Andrew Durden, Alpharetta, GA (US)

(73) Assignee: AT&T Intellectual Property I, L.P., Atlanta, GA (US)

(21) Appl. No.: 17/678,616

(22) Filed: Feb. 23, 2022

(51) Int. Cl. G06Q 10/06; G06V 20/52; G06V 20/40

(52) U.S. Cl. CPC G06Q 10/063114; G06Q 10/06312; G06V 20/52; G06V 20/44

(57) ABSTRACT

Aspects of the subject disclosure may include, for example, obtaining a group of images of a premises from a group of cameras associated with a first time period, generating computer vision data associated with a premises from the group of images for a first time period utilizing a group of image recognition techniques, obtaining employee schedule information associated with the premises for the first time period, and obtaining point-of-sale information associated with the premises for the first time period. Further embodiments include determining a first walk-out metric associated with the premises for the first time period according to the computer vision data, the employee schedule information, and the point-of-sale information. The first walk-out metric is based on a first number of customers leaving the premises without interacting with an employee associated with the premises during the first time period. Other embodiments are disclosed.

### FIELD OF THE DISCLOSURE

The subject disclosure relates to methods, systems, and devices to predict walk-out of customers associated with a premises.

### BACKGROUND

Operators of premises that deal with customers (e.g., retailers, financial institutions, service providers, etc.) would like to limit the number of customers that walk out without being served by employees associated with the premises/operator. In the current state of the art, accurate counting of customers for a premises have been limited to counting people who enter the premises that can include non-customers such as employees, delivery personnel, etc. Further, any estimation of walk-out of a customer or a time a customer may wait until walk-out have been inaccurate due to the inaccuracy of the number of customers associated with the premises.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2B are block diagrams illustrating example, non-limiting embodiments of a system functioning within the communication network of FIG. 1 in accordance with various aspects described herein.

FIGS. 2C-2E depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for obtaining a group of images of a premises from a group of cameras associated with a first time period, generating computer vision data associated with a premises from the group of images for a first time period utilizing a group of image recognition techniques, obtaining employee schedule information associated with the premises for the first time period, and obtaining point-of-sale information associated with the premises for the first time period. Further embodiments can include determining a first walk-out metric associated with the premises for the first time period according to the computer vision data, the employee schedule information, and the point-of-sale information. The first walk-out metric is based on a first number of customers leaving the premises without interacting with an employee or not engaged for a period of time after initial greeting by an employee associated with the premises during the first time period. Other embodiments are described in the subject disclosure.

One or more aspects of the subject disclosure include a device, comprising a processing system including a processor, and a memory that stores executable instructions that, when executed by the processing system, facilitate performance of operations. The operations comprising obtaining a group of images of a premises from a group of cameras associated with a first time period, generating computer vision data associated with a premises from the group of images for a first time period utilizing a group of image recognition techniques, obtaining employee schedule information associated with the premises for the first time period, and obtaining point-of-sale information associated with the premises for the first time period. Further operations can comprise determining a first walk-out metric associated with the premises for the first time period according to the computer vision data, the employee schedule information, and the point-of-sale information. The first walk-out metric is based on a first number of customers leaving the premises without interacting with an employee associated with the premises during the first time period.

One or more aspects of the subject disclosure include a non-transitory, machine-readable medium, comprising executable instructions that, when executed by a processing system including a processor, facilitate performance of operations. The operations can comprise obtaining a group of images of a premises from a group of cameras associated with a first time period, generating computer vision data associated with a premises from the group of images for a first time period utilizing a group of image recognition techniques, obtaining employee schedule information associated with the premises for the first time period, and obtaining point-of-sale information associated with the premises for the first time period. Further operations can comprise determining a first walk-out metric associated with the premises for the first time period according to the computer vision data, the employee schedule information, and the point-of-sale information. The first walk-out metric is based on a first number of customers leaving the premises without interacting with an employee associated with the premises during the first time period. Additional operations can comprise determining an average transaction time for a customer associated with the premise, generating a walk-out queuing model based on the computer vision data, the employee schedule information, the point-of-sale information (e.g., about employees presence on the sales floor), and the average transaction time (e.g., mathematically estimated for an average time based on historical transactional data), identifying a walk-out metric threshold (e.g., minutes of wait time) based on the walk-out queuing model, and determining a second walk-out metric is less than the walk-out metric threshold for a second time period based on the walk-out queuing model.

One or more aspects of the subject disclosure include a method. The method can comprise obtaining, by a processing system including a processor, a group of images of a premises from a group of cameras associated with a premises, generating computer vision data associated with a premises from the group of images for a first time period utilizing image recognition techniques, obtaining, by the processing system, employee schedule information associated with the premises for the first time period, and obtaining, by the processing system, point-of-sale information associated with the premises for the first time period. Further, the method can comprise determining, by the processing system, a first walk-out metric associated with the premises for the first time period according to the computer vision data, the employee schedule information, and the point-of-sale information. The first walk-out metric is based on a first number of customers leaving the premises without interacting with an employee associated with the premises during the first time period. In addition, the method can comprise determining, by the processing system, an average transaction time for a customer associated with the premise, generating, by the processing system, a walk-out queuing model based on the computer vision data, the employee schedule information, the point-of-sale information, and the average transaction time, determining, by the processing system, a walk-out tolerance associated with the premises, and determining, by the processing system, an employee schedule associated with the premises for a second time period based on the walk-out queuing model, and the walk-out tolerance.

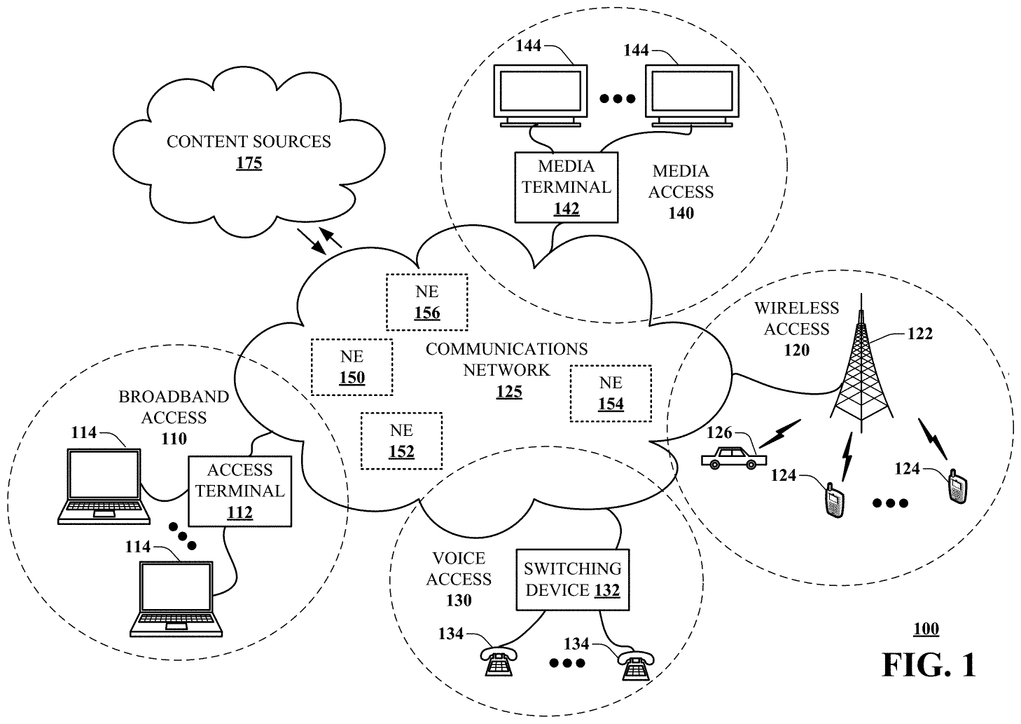

Referring now to FIG. 1, a block diagram is shown illustrating an example, non-limiting embodiment of a system 100 in accordance with various aspects described herein. For example, system 100 can facilitate in whole or in part predicting customer walk-out likelihood (e.g., propensity) based on computer vision data, employee schedule information, and/or POS information. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

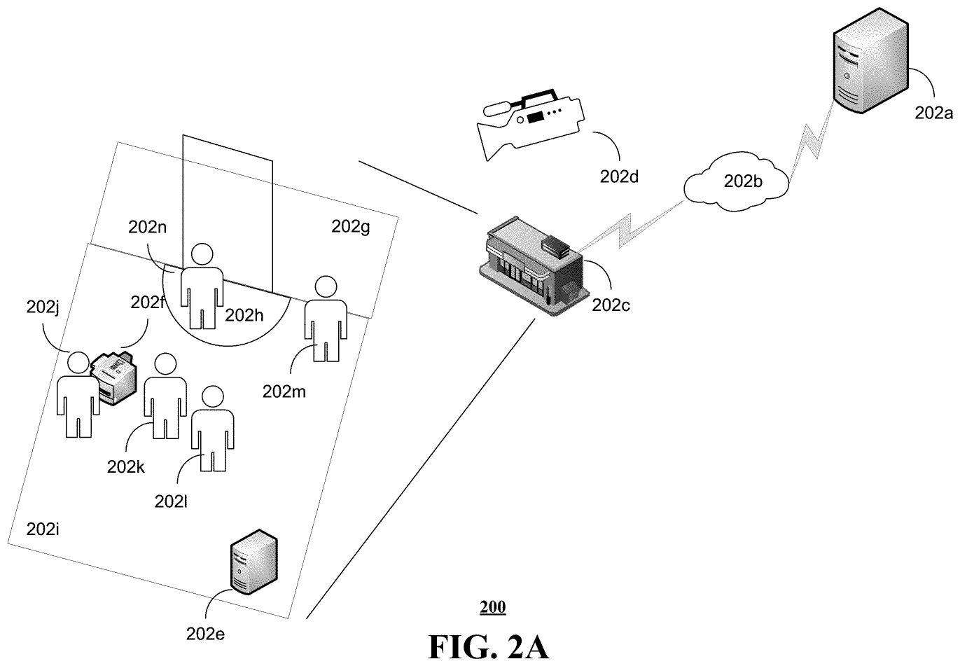

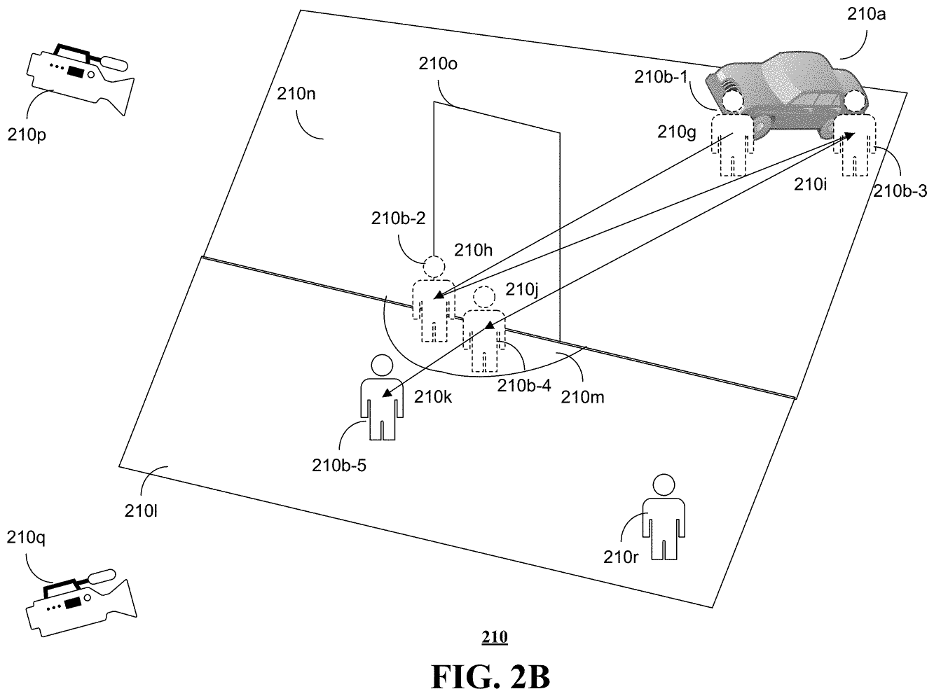

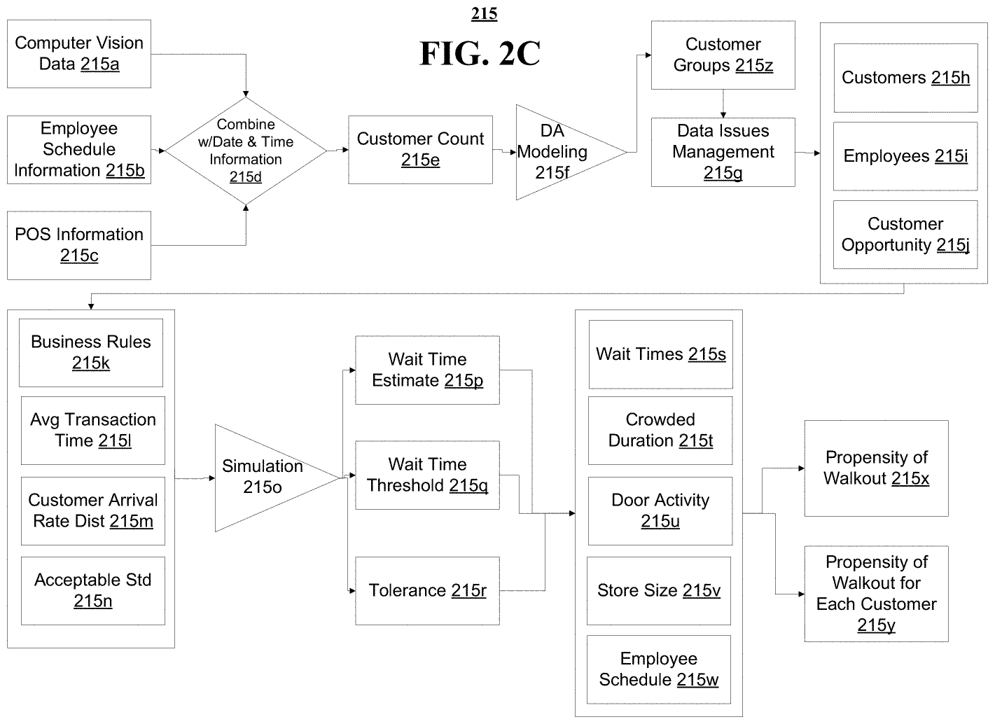

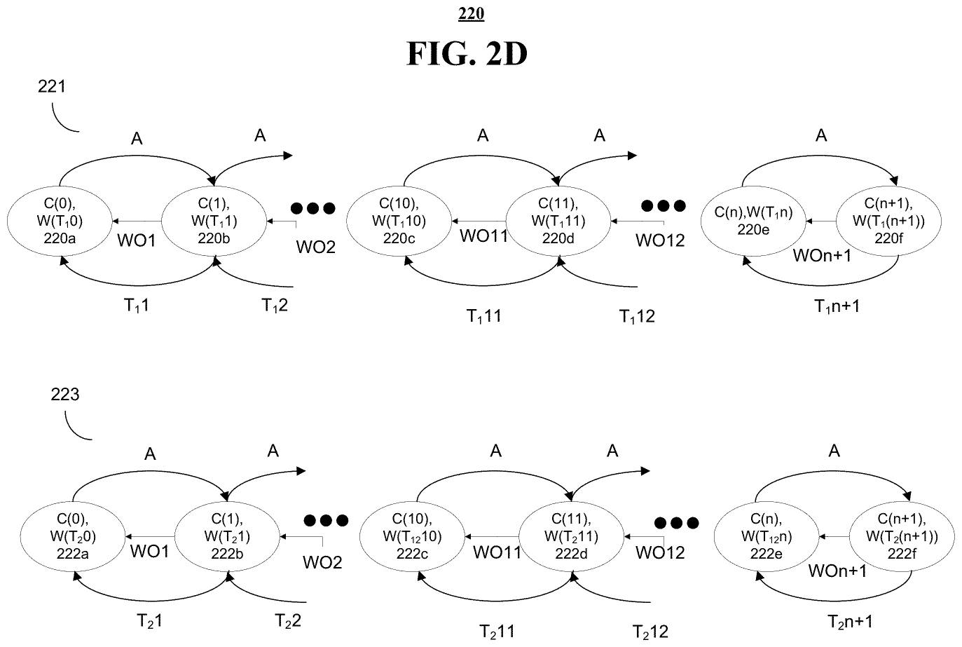

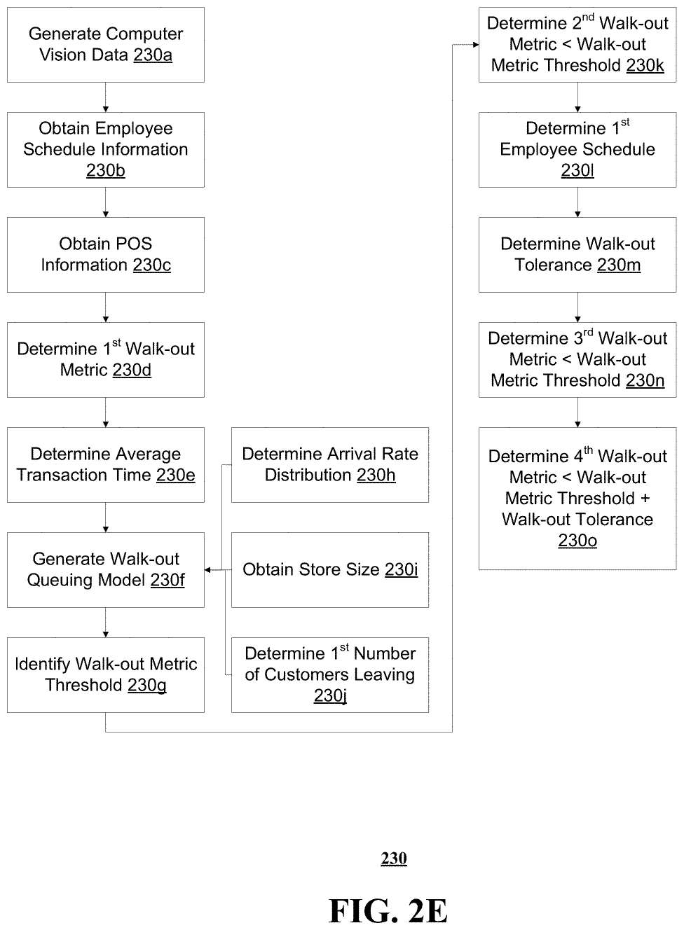

FIGS. 2A-2B are block diagrams illustrating example, non-limiting embodiments of a system functioning within the communication network of FIG. 1 in accordance with various aspects described herein. Referring to FIG. 2A, in one or more embodiments, the system 200 comprises a server 202a communicatively coupled to a camera 202d, a premises server 202e and a point-of-sale (POS) terminal 202f associated with a premises 202c over a communication network 202b. Communication network 202b can comprise a wireless communication network, a wired communication network, and/or a combination thereof. Further, each of server 202a and premises server 202e can comprise one or more servers in one location or spanning multiple locations, one or more virtual servers in one location or spanning multiple locations, one or more cloud servers, or a combination thereof.

In one or more embodiments, server 202a can determine a likelihood (e.g., propensity) of a customer walk-out of the premises without being served by an employee. As part of making such a determination, the server 202a can determine a number of customers at the premises 202c during a time period. The camera 202d can capture images of the interior of the premises that can include images of the potential customer 202k, potential customer 202l, potential customer 202m, and potential customer 202n as well as employee 202j of the operator of the premises 202c. Further, the captured images can be part of computer vision data provided to the server 202a. In one or more embodiments, the captured images may or may not be discarded or otherwise deleted after analysis and data generation has been performed, such as deletion at the end of the day or another time frame.

As part of generating the computer vision data, the server 202a can demarcate an interior zone 202i, an exterior zone 202g, and an entranceway zone 202h to assist in determining whether the potential customers are actual customers (e.g., positive identification of employees or delivery personnel and other non0customers). In addition, the operator of the premises 202c can be a financial institution or a service provider such that each customer is associated with an account with the operator. The server 202a can utilize image recognition techniques and determine whether potential customer 202k and potential customer 202l are companions (e.g., spouses, significant others, siblings, etc.) to one another or otherwise associated with each other such as siblings and friends and share account (e.g., by determining whether they are in proximity to one another for a threshold period of time and/or speak to one another for another threshold period of time). Also, the server 202a can utilize image recognition techniques to determine whether potential customer 202n is delivery personnel by recognizing that the potential customer 202n is wearing apparel associated with a delivery operator. Other techniques and information can be analyzed and/or obtained for determining individuals that are associated with each other, such as identifying mobile devices that are associated with a same subscriber plan. Thus, the computer vision data can be used to assist in determining the number of customers within the premises 202c during the time period. In one or more embodiments, capturing images and/or analyzing of images can be performed according to notice to customers (e.g., signs, etc.) and/or other express or implied authorization of the customers. Further details of generation of the computer vision data are discussed when describing FIG. 2B.

In one or more embodiments, the server 202a can determine the likelihood of a customer walk-out not only based on the number of customers in the time period based on the computer vision data, but also from employee schedule information stored on premises server 202e and POS data obtained from POS terminal 202f. Employee schedule information can be utilized to determine the number of employees working during the time period to serve customers and the POS data can be utilized to determine how many employees are on the floor interacting with customers and/or how many customers purchased items (e.g., goods and/or services). Based on the computer vision data, the employee schedule information, and the POS data, a walk-out queuing model can be generated by the server 202a to identify different walk-out metrics to determine a likelihood of customer-walk-out for the time period. Different walk-out metrics can include, but are not limited to, wait time for a group of customers, wait time for a particular customers walk-out likelihood (e.g., propensity), crowded duration, etc. Further details of walk-out metrics are discussed when describing FIG. 2C. Further details of the generation of the walk-out queuing model are discussed when describing FIG. 2D.

In one or more embodiments, as an example, the walk-out queuing model can assist in determining whether customer 202k and customer 202l are companions (e.g., spouses, significant others, siblings, etc.) thereby sharing an account and can be served by employee 202j collectively, or are customers that are not related in any way such that they have different accounts and need to be served individually by employee 202j. Thus, there may be greater likelihood for customer 202m to walk-out if customer 202k and customer 202l are not related and need to be served individually by employee 202j than if customer 202k and customer 202k are related and are served collectively. In addition, the determining the number of customers, and the number of employees can determine the likelihood of customer walk-out. For example, if more than one employee was being served to address customer 202k and customer 202l at the same time, customer 202m is less likely to walk-out.

Referring to FIG. 2B, in one or more embodiments, system 210 comprises a group of images of premises 202c captured by during a time period and provided to a server 202a by camera 210p and camera 210q (both associated with premises 202c). Further the server 202a can demarcate several zones within each image of the group of images that include an exterior zone 210n, an entranceway zone 210m inside the premises near a doorway 210o, and an interior zone 210l within the premises 202c (excluding the entranceway zone 210m). The server 202a counts a person as a potential customer only when the person is detected to be in the interior zone 210l. For example, in a first image at a time event 210g, person 210b-1 is detected to be in the exterior zone 210n near their parked vehicle 210a. In response to being detected in exterior zone 210n, the server 202a does not count person 210b-1 at time event 210g as a potential customer. In a second image at a time event 210h, (same) person 210b-2 enters the premises and is detected to be in entranceway zone 210m. In response to being detected in the entranceway zone 210m, the server 202a does not count person 210b-2 at time event 210h as a potential customer. In a third image at a time event 210i, (same) person 210b-3 exits the premises and is detected to be in the exterior zone 210n, near their parked vehicle 210a (i.e., possible forgetting something in their car). In response to being detected in the exterior zone 210n, the server 202a does not count person 210b-3 at time event 210i as a potential customer. In a fourth image at a time event 210j, (same) person 210b-4 enters the premises and is detected to be in entranceway zone 210m. In response to being detected in the entranceway zone 210m, the server 202a does not count person 210b-4 (yet) at time event 210j as a potential customer (i.e., the person 210b-4 may exit the premises from entranceway zone 210m because they entered the wrong store, forgot something else in their car, etc.). In a fifth image at a time event 210k, (same) person 210b-5 enters the premises 202c and is detected to be in interior zone 210l. In response to being detected in the interior zone 210l, the server 202a does count person 210b-2 at time event 210j as a potential customer. Thus, by demarcating the images captured by camera 210p and camera 210q, and counting customers that only are detected in the interior zone 210l, the server 202a limits the double counting of potential customers, thereby providing a more accurate number of customers entering the premises.

In one or more embodiments, at each time event 210g, 210h, 210i, 210j, and 210k, the server 202a detects potential customer 210b-x in each image. The server 202a can employ image recognition techniques/technologies that recognize the same person (e.g., through facial recognition, clothing apparel, combination thereof, etc.) in a set of consecutive chronological images and counts the person as one, potential customer rather than more than one potential customer and track a person while within camera range (e.g., through recognition of movements and tracking the moving path). The set of consecutive chronological images that include the demarcation of the exterior zone 210n, entranceway zone 210m, and interior zone 210l, can be part of the computer vision data. In some embodiments, the computer vision techniques described in FIG. 2A and 2B can be called (premises) door activity (DA) modeling.

FIGS. 2C-2E depict illustrative embodiments of methods in accordance with various aspects described herein. Referring to FIG. 2C, method 215 can be implemented by a server (e.g., server 202a in FIG. 2A). The method 215 can include the server, at 215a, obtaining a group of images from a group of cameras associated with a premises and generating the computer vision data from the group of images. Further, the method 215 can include the server, at 215b, obtaining the employee schedule information (e.g., from a premises server). In addition, the method 215 can include the server, at 215c, obtaining POS information (e.g., from a POS terminal or premises server). Also, the method 215 can include the server, at 215d, can combine and process the computer vision data, employee schedule information, and POS information with the data and time information.

In one or more embodiments, the method 215 can include the server, at 215e, determining the (potential) customer count from processing the computer vision data. Further, the method 215 can include the server, at 215f, implementing the door activity modeling as described in FIG. 2A and FIG. 2B. In addition, the method 215 can include the server, at 215z, determining customer groups (e.g., two customers are spouses of one another and share one customer account) from the DA modeling. In addition, the method 215 can include the server, at 215g, managing any data issues that can include determining and/or correcting missing or erroneous data. Also, the method 215 can include the server, at 215h, at 215i, and at 215j, to determine the number of customers, the number of employees, and the number of customer opportunities, respectively, from the inputs from the computer vision data, employee schedule information, and the POS information and servers processing the data (215d through 215g).

In one or more embodiments, the method 215 can include the server, at 215k obtaining business rules (e.g., employees should address customer within 5 minutes of entry, a threshold percentage of customers should purchase an item, etc.) from an operator database, and at 215l, obtaining the average transaction time for an employee associated with the premises to serve a customer or the average transaction time for each employee individually to serve a customer from an operator database. Further, the method 215 can include the server, at 215m, determining the customer arrival rate distribution of a group of customers in a given timeframe typically hourly from the computer vision data, and at 215n, determining an acceptable standard deviation for the high variance variable like customer arrival rate from the computer vision data or customer transaction time from the POS information. The method 215 can include the server generating a walk-out queuing model based on the computer vision data, employee schedule information, POS information, business rules, average transaction time, and customer arrival rate distribution.

In one or more embodiments, the method 215 can include the server, at 215o, running/performing one or more simulations of the walk-out queuing model with various parameters (e.g., number of customers, number of employees, etc.). Further, the method 215 can include the server, at 215p, determining a wait time estimate for a customer for a time period from the simulation(s). This can include wait time estimates for hundreds of employee to customer scenarios. In addition, the method 215 can include the server, at 215q, determining a wait time threshold before a customer walk-out from the simulation(s) (wait time and customer resentment are directly proportional). Also, the method 215 can include the server, at 215r, determining a wait time tolerance (e.g., above the wait time threshold) before a customer walk-out from the simulation(s) (tolerance can be how long a condition must persist to call out significant issue).

In one or more embodiments, the method 215 can include the server, at 215s, at 215t, at 215u, at 215v, at 215w, assembling together data and insights from 215a through 215r including wait times (e.g., an estimate of 20 minutes wait time), crowded duration (e.g., crowding prevailed for 30 minutes between 12 noon and 1 pm hour), door activity (e.g., number of customers walk-ins during crowded condition), store size, and employee count to determine the propensity and quantity of a walk-out based on the one or more simulations of the walk-out queuing model. This can include, for example, determining that a 25-30 min wait is above a wait time threshold and persists for over 30 minutes (e.g., crowded duration) as well as determining the number of customers that may walk-out during the crowded duration. Also, the smaller the store size, the more of a feeling of being crowded (e.g., lengthens crowded duration based on the walk-out queuing model) by customers increases likelihood of customer walk-out. Further, the number of employees can vary the crowded duration (e.g., employees servicing 1-2 customers in a queue is perceived a longer wait time than 4 employees and 1-2 customer in a queue). In addition, the method 215 can include the server, at 215x, determining walk-out propensity from the one or more simulations (e.g., walk-out propensity or likelihood can comprise tabular data by store, date, time, range, conditions). Also, the method 215 can include the server, at 215y, determining walk-out propensity (likelihood) for each waiting customer (e.g., third customer in queue has a higher walk-out likelihood than first two customers already in the queue).

Referring to FIG. 2D, in one or more embodiments, method 220 can include a group of walk-out queuing models 221, 223 implemented by a server (e.g., server 202a in FIG. 2A) during one or more simulations to determine an employee schedule. Each walk-out queuing model 221, 223 can comprise multiple states, each state representing the number of customers in a premises and the wait time for each customer as well as the arrival rate, A, of the customer that moves the queuing model from a previous state to a later state and an average transaction time or a likelihood of walk-out (WOn) that also moves the queuing model from a later state to a previous state. The arrival rate can be found from determine the arrival rate distribution (e.g., exponential distribution, uniform distribution, heavy-tailed or Pareto distribution, normal distribution, or combination thereof, for different time periods or for part of a timer period). For example, in queueing model 221, state C(11), W(T₁11) represents there are eleven customers at the premises and the wait time for each customer can be an array or table (e.g., T₁ 11 is the average transaction time to service a customer when there are eleven customers). That is, if a simulation running the walk-out queuing models 221, 223, includes 5 employees are servicing 11 customers and each employees has an average transaction time of 5 minutes, then the first five customers have zero wait time, the sixth through tenth customers have a 5 minute wait, and the eleventh customer has a wait time of 10 minutes. If the wait time threshold is 7 minutes with 2 minutes of the wait time tolerance, then there is a high likelihood that the eleventh customer will leave. Thus, the server can adjust the employee schedule to increase the number of employees for the time period (e.g., from 5 employees to 6 employees) to decrease the wait time for the eleventh customer to be below the wait time threshold (e.g., 5 minutes wait time). Adjusting the employee schedule can include adjust the timing of employee breaks to that a queuing of customers is handled more efficiently. Adjusting the employee schedule can include adjusting roles such as assigning an employee from stocking inventory in a backroom to addressing customer needs in a front room. Further, the adjustment of the employee schedule can include determining an employee at a sister premises is available to be assigned to a current premises to address customer needs. Note, walk-out queuing model 221 can have a different average transaction time (T₁) than walk-out queuing model 223 (T₂).

Referring to FIG. 2E, in one or more embodiments, aspects of the method 230 can be implemented by a server (e.g., server 202a in FIG. 2A). The method 230 can include the server, at 230a, generating computer vision data associated with a premises for a first time period from a group of images obtained from a group of cameras associated with the premises for the first time period. Further, the method 230 can include the server, at 230b, obtaining employee schedule information associated with the premises for the first time period. In addition, the method 230 can include the server, at 230c, obtaining point-of-sale information associated with the premises for the first time period. Also, the method 230 can include the server, at 230d, determining a first walk-out metric associated with the premises for the first time period according to the computer vision data, the employee schedule information, and the point-of-sale information. The first walk-out metric is based on a first number of customers leaving the premises without interacting with an employee associated with the premises during the first time period. Examples of a walk-out metric can be customer walk-out likelihood (e.g., propensity or probability), wait time, crowded duration, etc.

In one or more embodiments, the method 230 can include the server, at 230e, determining an average transaction time for a customer associated with the premises. Further, the method 230 can include the server, at 230f, generating a walk-out queuing model based on the computer vision data, the employee schedule information, the point-of-sale information, and the average transaction time. In addition, the method 230 can include the server, at 230g, identifying a walk-out metric threshold based on the walk-out queuing model. Also, the method 230 can include the server, at 230h, determining an arrival rate distribution associated with a group of customers for the walk-out queuing model based on the computer vision data. In some embodiments, the identifying of the walk-out metric threshold comprises identifying the walk-out metric threshold based on the arrival rate distribution. Further, the method 230 can include the server, at 230i, obtaining a store size associated with the premises for the walk-out queuing model. In other embodiments, the identifying of the walk-out metric threshold comprises identifying the walk-out metric threshold based on the store size. In addition, the method 230 can include the server, at 230j, determining a number of customers leaving the premises based on the computer vision data for a given simulation of the walk-out queuing model.

In one or more embodiments, the method 230 can include the server, at 230k, determining a second walk-out metric is less than the walk-out metric threshold for a second time period based on the walk-out queuing model. Further, the method 230 can include the server, at 230l, determining a first employee schedule associated with the premises for the second time period based on the second walk-out metric. In addition, the method 230 can include the server, at 230m, determining a walk-out tolerance associated with the premises. The method 230 can include the server determining a second employee schedule associated with the premises for a third time period based on the walk-out queuing model and the walk-out tolerance. The third time period comprises a fourth time period and a fifth time period. Further, the method 230 can include the server, at 230n, determining a third walk-out metric for the fourth time period is less than the walk-out metric threshold. In addition, the method 230 can include the server, at 230o, determining a fourth walk-out metric for the fifth time period is less than a sum of the walk-out metric threshold and the walk-out tolerance.

In one or more embodiments, current employees can be provided real-time feedback (e.g., instant auto message alerts, text messages, etc.) that a customer queue is building and customer walk-out can be imminent so that they can address the customer needs faster. Further, a manager of the employees can be provided real-time feedback (e.g., instant message, text message, etc.) that a customer queue is building and customer walk-out can be imminent so that they can adjust employee schedule and/or roles to address customers' needs. Further, other information can be analyzed to facilitate managing the customer queues such as determining a waiting customer's intent to buy vs. browsing according to past purchasing history (e.g., embodiments can identify individuals from the images and identify past purchasing—all done with the consent of the customer).

One or more embodiments can include an outdoor application to estimate crowding condition utilizing computer vision and other given data e.g., staff or security personals and deploy edge computing devices or utilize 5G wireless system for the fast data to the cloud or a server for the processing and developing near real time insights or alter system

One or more embodiments can include deployment of Bluetooth® sensors to identify and locate employees (E1) e.g. care givers, staff or security personals and computer vision to detect people (P1) to continuously observe the ratio between P1 and E1 for it to not fall below a threshold. In doing so, use communication services e.g. 5G network or Wi-Fi to send notifications like an alert, log updates. While for purposes of simplicity of explanation, the respective processes are shown and described as a series of blocks in FIG. 2C-2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. One or more block may be performed in response to one or more other blocks.

Further, portions of some embodiments can be combined with portions of other embodiments.

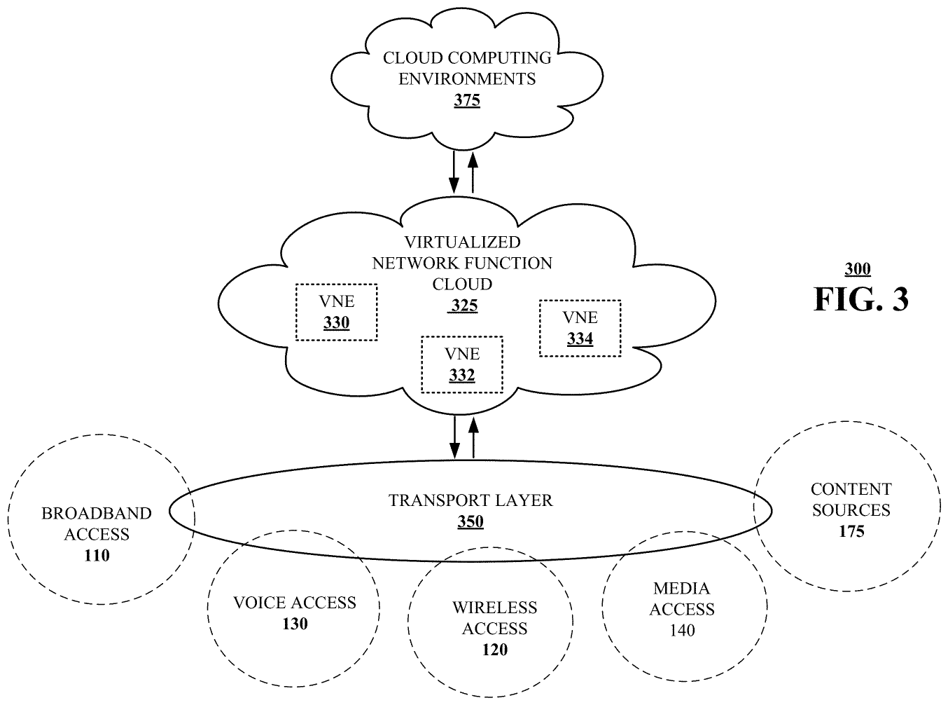

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems 200, 210, and methods 215, 220, 230 presented in FIGS. 1, 2A-2E, and 3. For example, virtualized communication network 300 can facilitate in whole or in part predicting customer walk-out likelihood (e.g., propensity) based on computer vision data, employee schedule information, and/or POS information.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

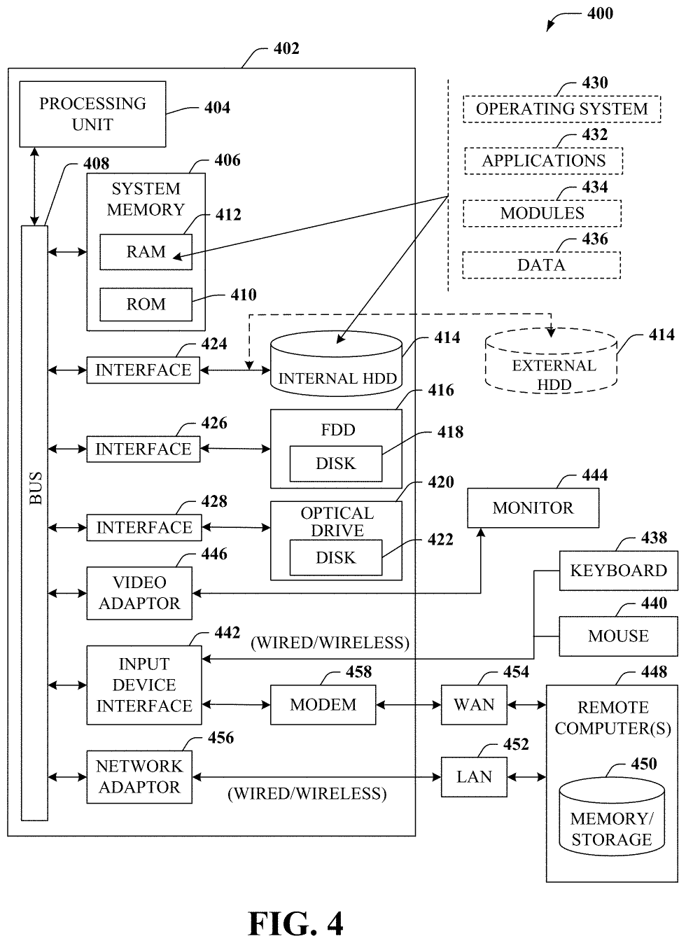

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part predicting customer walk-out likelihood (e.g., propensity) based on computer vision data, employee schedule information, and/or POS information. Further, each of server 202a, camera 202d, premises server 202e, POS terminal 202f, camera 210p, and camera 210q comprise computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

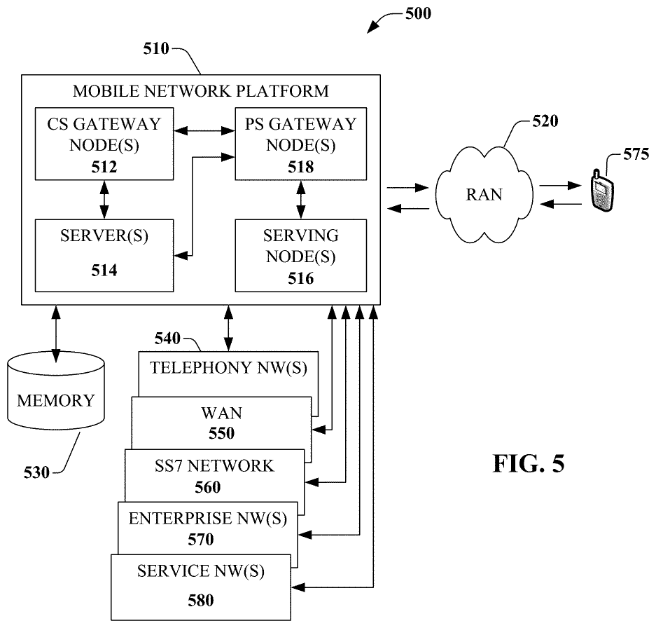

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part predicting customer walk-out likelihood (e.g., propensity) based on computer vision data, employee schedule information, and/or POS information. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

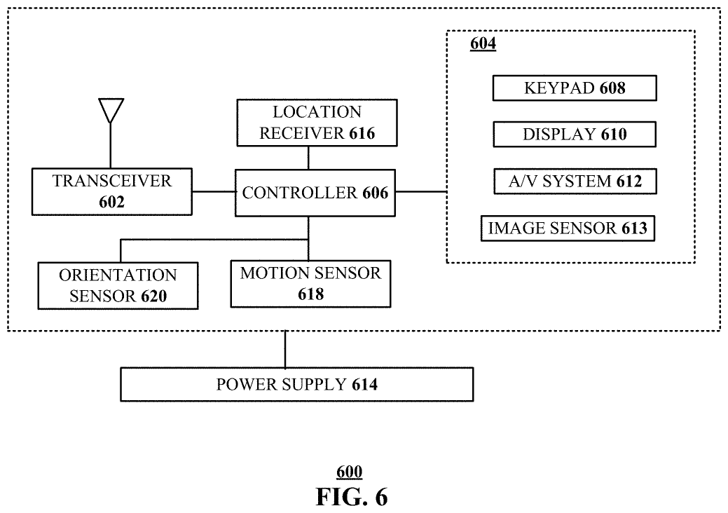

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part predicting customer walk-out likelihood (e.g., propensity) based on computer vision data, employee schedule information, and/or POS information. Further, each of server 202a, camera 202d, premises server 202e, POS terminal 202f, camera 210p, and camera 210q comprise communication device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a group of images of a premises from a group of cameras associated with a first time period;
generating computer vision data associated with the premises from the group of images for the first time period utilizing a group of image recognition techniques;
obtaining employee schedule information associated with the premises for the first time period;
obtaining point-of-sale information associated with the premises for the first time period; and
determining a first walk-out metric associated with the premises for the first time period according to the computer vision data, the employee schedule information, and the point-of-sale information, wherein the first walk-out metric is based on a first number of customers leaving the premises without interacting with an employee associated with the premises during the first time period.

2. The device of claim 1, wherein the operations comprise:
determining an average transaction time for a customer associated with the premises;
generating a walk-out queuing model based on the computer vision data, the employee schedule information, the point-of-sale information, and the average transaction time; and
identifying a walk-out metric threshold based on the walk-out queuing model.

3. The device of claim 2, wherein the operations comprise determining an arrival rate distribution associated with a group of customers for the walk-out queuing model based on the computer vision data, wherein the identifying of the walk-out metric threshold comprises identifying the walk-out metric threshold based on the arrival rate distribution.

4. The device of claim 2, wherein the operations comprise obtaining a store size associated with the premises for the walk-out queuing model, wherein the identifying of the walk-out metric threshold comprises identifying the walk-out metric threshold based on the store size.

5. The device of claim 2, wherein the operations comprise determining a second walk-out metric is less than the walk-out metric threshold for a second time period based on the walk-out queuing model.

6. The device of claim 5, wherein the operations comprise determining a first employee schedule associated with the premises for the second time period based on the second walk-out metric.

7. The device of claim 2, wherein the operations comprise determining a walk-out tolerance associated with the premises.

8. The device of claim 7, wherein the operations further comprise determining a second employee schedule associated with the premises for a third time period based on the walk-out queuing model and the walk-out tolerance.

9. The device of claim 8, wherein the third time period comprises a fourth time period and a fifth time period.

10. The device of claim 9, wherein the operations comprise determining a third walk-out metric for the fourth time period is less than the walk-out metric threshold.

11. The device of claim 9, wherein the operations comprise determining a fourth walk-out metric for the fifth time period is less than a sum of the walk-out metric threshold and the walk-out tolerance.

12. The device of claim 1, wherein the determining the first walk-out metric comprises determining the first number of customers leaving the premises based on the computer vision data.

13. A non-transitory, machine-readable medium, comprising executable instructions that, when executed by a processing system including a processor, facilitate performance of operations, the operations comprising:
obtaining a group of images of a premises from a group of cameras associated with a first time period;
generating computer vision data associated with the premises from the group of images for the first time period utilizing a group of image recognition techniques;
obtaining employee schedule information associated with the premises for the first time period;
obtaining point-of-sale information associated with the premises for the first time period;
determining a first walk-out metric associated with the premises for the first time period according to the computer vision data, the employee schedule information, and the point-of-sale information, wherein the first walk-out metric is based on a first number of customers leaving the premises without interacting with an employee associated with the premises during the first time period;
determining an average transaction time for a customer associated with the premise;
generating a walk-out queuing model based on the computer vision data, the employee schedule information, the point-of-sale information, and the average transaction time;
identifying a walk-out metric threshold based on the walk-out queuing model; and
determining a second walk-out metric is less than the walk-out metric threshold for a second time period based on the walk-out queuing model.

14. The non-transitory, machine-readable medium of claim 13, wherein the operations further comprise determining an arrival rate distribution associated with a group of customers for the walk-out queuing model based on the computer vision data, wherein the identifying of the walk-out metric threshold comprises identifying the walk-out metric threshold based on the arrival rate distribution.

15. The non-transitory, machine-readable medium of claim 13, wherein the operations comprise obtaining a store size associated with the premises for the walk-out queuing model, wherein the identifying of the walk-out metric threshold comprises identifying the walk-out metric threshold based on the store size.

16. The non-transitory, machine-readable medium of claim 13, wherein the operations comprise determining a first employee schedule associated with the premises for the second time period based on the second walk-out metric.

17. A method, comprising:
obtaining, by a processing system including a processor, a group of images of a premises from a group of cameras associated with a first time period;
generating, by the processing system, computer vision data associated with the premises from the group of images for the first time period utilizing a group of image recognition techniques;
obtaining, by the processing system, employee schedule information associated with the premises for the first time period;
obtaining, by the processing system, point-of-sale information associated with the premises for the first time period;
determining, by the processing system, a first walk-out metric associated with the premises for the first time period according to the computer vision data, the employee schedule information, and the point-of-sale information, wherein the first walk-out metric is based on a first number of customers leaving the premises without interacting with an employee associated with the premises during the first time period;
determining, by the processing system, an average transaction time for a customer associated with the premise;
generating, by the processing system, a walk-out queuing model based on the computer vision data, the employee schedule information, the point-of-sale information, and the average transaction time; and
determining, by the processing system, a walk-out tolerance associated with the premises; and
determining, by the processing system, an employee schedule associated with the premises for a second time period based on the walk-out queuing model, and the walk-out tolerance.

18. The method of claim 17, wherein the second time period comprises a third time period and a fourth time period.

19. The method of claim 18, comprising determining, by the processing system, a second walk-out metric for the third time period is less than a walk-out metric threshold.

20. The method of claim 19, comprising determining, by the processing system, a third walk-out metric for the fourth time period is less than a sum of the walk-out metric threshold and the walk-out tolerance.
